(19) United States
(12) Patent Application Publication
(10) Pub. No.: US 2004/0045978 A1
(43) Pub. Date: Mar. 11, 2004

(54) Dispenser

(76) Inventors: Steven Peng, Fresno, CA (US); Antony Chiang, San Francisco, CA (US)

Correspondence Address: LAW OFFICE OF ALAN W. CANNON, 834 SOUTH WOLFE ROAD, SUNNYVALE, CA, 94086, US

(21) Appl. No.: 10/639,166

(22) Filed: Aug. 12, 2003

Related U.S. Application Data
(60) Provisional application No. 60/407,806, filed on Sep. 4, 2002.

(51) Int. Cl. B65H 1/00; G07F 11/00

(52) U.S. Cl. 221/312 R

(57) ABSTRACT

Dispensing devices and assemblies for controllably dispensing a predefined number of items, or predefined volume of a flowable substance, at a time. Dispensation is accomplished by a simple tilting motion that can be effected with a single hand of a user.

### CROSS-REFERENCE

This application claims the benefit of U.S. Provisional Application No. 60/407,806, filed Sep. 4, 2002, and titled “Controlled Pill-Dispensing Insert”, which application is incorporated herein, in its entirety, by reference thereto.

### FIELD OF THE INVENTION

The present invention relates to the field of dispensers. More particularly, the present invention relates to dispensers adapted to dispense medicines such as pills, tablets, pellets, caplets, capsules; food items such as candy, nuts, gum or other edible items; vitamins; pet foods; hardware items such as screws, bolts, nuts or the like; office supply items; even liquids, or other physical items in which it is desired to limit the amount dispensed per each act of dispensation.

### BACKGROUND OF THE INVENTION

Standard prescription and over the counter medication bottles are almost always designed in such as way as to render it very difficult to dispense one or two pills from the bottle as needed. This is generally true whether the medication is in pill form, tablet form, capsule form, caplet form or any other currently popular shape or delivery design that the medication is formed in. The openings of the medication bottles are generally too small to reach into, but are sufficiently large such that when the bottle is tilted to dispense the medication, a large number of pills, tablets, or whatever form the medication takes, are dispensed into the hand of the user or onto the table.

Since there is no effective control mechanism to positively dispense only the needed amount of medication, the excess pills must then be returned to the bottle. This repetitive act of dispensing and returning pills that are not needed for the current dose not only increases the possibility of contaminating the medication as it is returned to the bottle, but the necessity of such is inconvenient, aggravating and also increases the chances of spilling the medication onto the floor or other unsanitary surface, as well as losing a portion of the medication. With the ever increasing costs of medication, better dispensing mechanisms are needed to ensure that a patient can dispense accurately only the amount of medication that is needed for the current dose.

The problems associated with the current dispensers are exacerbated with regard to older or disabled patients who may have arthritis, or even just decreased motor skills or use of only one arm or hand. Further, such patients may have difficulty seeing the pills to count them to the correct dosage. A dispenser that could positively dispense a single pill, tablet, caplet, etc. would have the further benefit that a sight challenged patient could count the number of pills he or she were taking by simply counting the number of times that the dispensing bottle is tilted, as it positively dispenses one pill with each tilt.

Further, such a single dosage dispenser can be a valuable deterrent to overdosing a patient intentionally or especially unintentionally.

Similar problems exist with regard to certain candies, mints, and the like which are sold loosely in a container of individual pieces of an item which is dispensed when it is desired to be eaten. Likewise, a jar of nuts or bolts often makes it difficult to remove only one or two of such items without pouring out a significant portion of the contents of the jar and then having to replace those which were not intended to be dispensed. Similar situations are presented across many fields, where a plurality of items are stored in a container, but do not have an effective dispensation mechanism to accurately control dispensation of only the number of those items needed by the user at any particular time.

There have been previous attempts to provide a dispenser for dispensing one pill at a time. U.S. Pat. No. 2,838,204 to Snyder discloses a pill dispenser having a single piece design. The dispensing portion is a flat-walled tube of resilient material having a longitudinal slit through which individual pills are manually manipulated therethrough. The pill dispenser provides protection from moisture or other forms of contamination. However, a substantial amount of manipulation is required to dispense a pill, which could be a drawback for physically challenged patients, such as arthritics and elderly patients.

U.S. Pat. No. 3,257,029 to Snyder describes a pill dispenser having a two piece design adapted to engage the neck of a pill container. The user is required to rotate one piece of the design with respect to another to effect dispensing of a pill by a series of successive rotative movements while the container is held upside down. This design also requires a significant amount of coordination for operation, together with holding the bottle in an upside down orientation while the manipulations are being carried out.

U.S. Pat. No. 3,991,908 to Thomas et al. discloses a pill dispensing cap assembly adapted for mounting on the neck of a pill container. The cap assembly includes a plurality of different components, including a rotor member to pick up a pill from the container and transfer it to a dispensing end. The design of the cap was directed towards nitroglycerin tablets and others of similar shape and size, and would have to be adapted for use with pills of different shapes and/or sizes. Also, the fairly complex arrangement of moving mechanical parts makes this a complicated and likely expensive design.

U.S. Pat. No. 4,653,668 to Gibilisco et al. discloses a container for storing and disposing objects, such as capsules or pills containing medicament, one at a time. The container comprises a receptacle containing, within itself, a delivery mechanism including a funnel-shaped exit port for capsules and a capsule or pill delivery tube at the end of said funnel-shaped exit designed to accommodate no more than one pill or capsule. The funnel divides the outer receptacle into an upper storage compartment and a lower delivery compartment. The receptacle also contains between the exit end of the receptacle and the delivery tube resilient gate members positioned to prevent or allow escape of a capsule or pill from the delivery tube. The inner end of the receptacle is pressed or twisted in the user's hand to move the resiliently mounted gate members so as to open them to allow passage of a single pill through the delivery tube. Upon releasing the pressure or twisting force, the resilient members resume their closed position. The delivery operation for this mechanism requires two-handed operation, as shown in FIGS. 2 and 3.

U.S. Pat. No. 4,887,738 to Jennings et al. discloses an article dispenser comprising a container portion in coaxial contiguous engagement with a dispenser control member for selective relative slidable motion therebetween. A flexible member is mounted to a dispenser portion of the container portion for engagement with the interior surface of the dispenser Pressure from the user's hand or other body surface is applied to actuate the sliding mechanism for release of a single pill.

U.S. Pat. No. 5,791,515 to Khan et al. discloses a one-at-a-time pill container and dispenser having a mechanism which allows for use of the device with existing containers. A child-proof lock is provided. The device has a mechanism for ensuring that only a single pill is brought into the dispensing chamber as a consequence of a partial rotation of the cap with respect to the bottle body. A reverse partial rotation of the cap then allows the pill to fall by gravity into the user's hand.

U.S. Pat. No. 6,267,265 to Issa discloses a pill dispenser having a conical shaped dispenser cavity that is hinged for rotation into alignment with the contents of a pill container and then for rotation out of alignment with the container after a pill is received within the conical shaped cavity. Upon rotation out of alignment, the conical shaped cavity is exposed for delivery of the contents to the hands of a user. Two hands are generally required in order to manipulate the conical shaped cavity between the “in” and “out of” alignment configurations.

U.S. Pat. No. 6,302,295 to Weisman discloses a prescription cap with a transparent daily dosage compartment. This is a replacement cap for replacing the cap of a standard pill bottle, and has a pair of through holes which can be rotated into alignment to allow pills to pass into the transparent compartment. Upon rotation out of alignment, pills cannot pass between the upper transparent compartment and the lower pill bottle.

While the prior art teaches effective means for dispensing pills one at a time, there are a number of inherent drawbacks in the disclosed designs, whether being overly difficult to operate for physically challenged users, overcomplicated making them unnecessarily expensive and not practical for universal use; requiring two hands to effectively operate; or restricted for only one style or size of compartment or pill.

Furthermore, in some instances the pill container requires modifications to mount the dispensing assembly. It is desirable to provide a dispensing mechanism which is readily useable with typical off-the-shelf containers and/or those provided at most pharmacies, or to provide a mechanism which may be effectively incorporated in existing containers and sold therewith. In general, there is a need to provide a dispenser that is less expensive to manufacture and/or assemble, is easy to use, and which involves only the simplest of motion by the user to gain access to the articles contained therein and in a quantity that is desired.

### SUMMARY OF THE INVENTION

An item dispensing device for controllably dispensing a predefined number of items at a time (or a predefined amount of liquid or flowable material, such as powder or the like) is provided, to include an outer container configured to contain a plurality of the items; a capture portion contained within the outer container and dividing the outer container between a reservoir space, where the plurality of items are stored, and a capture space, of appropriate size and shape where individual items (or predefined volumes of liquid or flowable substance) are captured for controlled dispensing; a connector contained within the outer container and defining a delivery channel from said capture portion to an opening in the outer container from which items are dispensed; a first end portion of said connector extending into an opening in said capture portion and defining a predetermined gap dimension through which only the predetermined number of items of certain size or volume may pass at one time; and a barrier connecting with a second end portion of said connector and preventing release of the plurality of items from the reservoir space when the predetermined number of items is dispensed from said connector.

Preferred examples of the present invention are configured to dispense only one item at a time.

The connector may be adjustable to adjust the predetermined gap dimension of the dispenser, to adapt it for dispensation of a different size of item. Alternatively, adjustment of the gap dimension may be carried out to controllably and accurately dispense two or more items at a time. Still further, a kit of connectors may be provided, each having a different length end portion, and which may be interchanged with one another to vary the predefined gap dimension.

The capture portion may include at least one funnel-shaped portion for focusing the flow of items into the capture space. The funnel-shaped portion may also serve as a separator which divides the reservoir from the capture space.

Items are gravitationally fed into the capture space, and are gravitationally dispensed, e.g., one at a time, upon executing a tilting motion of the container in which the dispensing components are contained. This tilting motion may be easily carried out, using only one hand, and is a natural and intuitive motion associated with dispensing.

The present invention may be manufactured together with a container, or may be manufactured as an assembly that is configured to be inserted into an existing container. In either case, the container may be cylindrical or other shape, including square and rectangular cross-sections, or any other predefined cross sectional shape forming a container having parallel or near parallel inner walls. The assembly may be manufactured as separate components such as separate connector and capture portions, or as separate barrier and connector/capture portions, or may be manufactured integrally.

The assembly is configured to be completely received within the container, so that a convention container cap can still be used to close the container to aid in preventing contamination as well as inadvertent dispensation of items.

Such an assembly includes a capture portion adapted to be contained within the container and positioned to divide the container between a reservoir space, where a plurality of items can be stored, and a capture space, where individual items (or predefined volumes of liquid or other flowable substance) are captured for controlled dispensing; a connector adapted to be contained within the item container and configured to define a delivery channel from the capture portion to an opening in the container from which items are dispensed. A first end portion of the connector is configured to extend into an opening in the capture portion to define a predetermined gap dimension through which only the predetermined number and size or volume of items may pass at one time. A barrier connects with a second end portion of the connector and is adapted to interface with inner walls of the container to prevent release of items from the reservoir space when the predetermined number of items is dispensed from the connector.

The preferred configuration of the assembly is for dispensation of only one item at a time. Successful capture is determined by a dynamic relationship between the capture portion size and shape and the gap to the connector. Optionally, the connector may be adjustable to adjust the predetermined gap dimension to allow more than one item to be dispensed with each tilting act and/or to dispense items of different size than the items for which the assembly was previously set up to dispense.

The capture portion may include a funnel-shaped separator.

The barrier and connector and the capture portion may be integrally formed, or each or any of these components may be formed separately and later assembled.

The assembly is adapted to be fitted within a container in a way that allows items to be gravitationally fed to the capture space. Further, the assembly is configured to dispense items by gravitational feed resultant from a simple tilting motion that may be accomplished by one hand of a user.

A method of dispensing items controllably, so that a predefined number of items is released at one time is disclosed to include the steps of: providing a dispensing device having a reservoir space, where a plurality of items are stored, and a capture space, where individual items are captured for dispensing; capturing an item by the force of gravity; and dispensing the item by a single tilting motion, while preventing items in the reservoir space from being dispensed.

The items may also be captured by gravity by the single tilting motion, prior to dispensation, which may be driven by the same tilting motion.

The dispensing and tilting may be accomplished by only one hand of a user.

The predefined number for dispensation is preferably one at a time. The predefined number of items released at one time is governed by a gap interfacing with a specifically designed capture space and having a predefined dimension. The predefined dimension of the gap and the capture space may be altered to dispense a different size item or change the predefined number of items to be dispensed at a time.

These and other advantages and features of the invention will become apparent to those persons skilled in the art upon reading the details of the invention as more fully described below.

### BRIEF DESCRIPTION OF THE DRAWINGS

FIG. 1A is a sectional view of an example of an item dispensing device according to the present invention.

FIG. 1B is a view of the device of FIG. 1 shown tilted in the process of dispensing an item.

FIG. 1C shows the device of FIG. 1C as it is tilted further to dispense and item

FIG. 1D illustrates prevention of the dispensation or spilling of additional items from the reservoir during a dispensation according to the present invention.

FIG. 2A is an isolated view of a connector according to the present invention.

FIG. 2B is an isolated view of a capture portion of a dispensing mechanism according to the present invention.

FIG. 3A is a view of an example of an item dispensing device which employs a funnel shaped separator having multiple reliefs.

FIG. 3B is a view of an example of an item dispensing device which includes a series of funnel-shaped features functioning as a separator.

FIGS. 4A-4D are a series of figs showing reinsertion of an item through a reinsertion feature.

FIGS. 5A-5C show an example of assembling a dispenser assembly, together with loading items into a container in which the assembly is placed.

### DETAILED DESCRIPTION OF THE INVENTION

Before the present dispenser and methods are described, it is to be understood that this invention is not limited to particular configurations, materials or items described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a capture mechanism” or “a funnel” includes a plurality of such capture mechanisms or funnels, and reference to “the shaft” includes reference to one or more shafts and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The present invention provides dispensing mechanisms for simply controlling the release of a predefined number of items. The mechanisms are preferably designed for release of one item at a time, although they may be designed, for example, to release two or more items at a time. Here forward, reference to an “item” is used not only to refer to a solid item of predefined size, shape and volume, but also to a predefined volume of liquid or other flowable material, such as powder, pellets and the like.

The mechanisms described are configured to be inserted into existing containers, so that they are more universally applicable to a wide variety of products. For example, a manufactured assembly (mechanism) according to the present invention may be configured to be slid into an existing medication bottle. Alternatively, the assembly (mechanism) according to the present invention may be manufactured as an integrated part of a bottle, where a cap, lid or closure is still employed to close off the entire assembly. Thus, the mechanisms described may be manufactured in their own containers and later filled by a product (item) manufacturer. Further alternatively, the mechanisms described, or a portion of any such mechanism, may be integrated with closures or other configurations. For example, a barrier (lid) as described herein, which prevents items from escaping from the reservoir as an item is being dispensed, may be integrated with a closure, lid or cap of a bottle. In such an example, the closure, lid or cap may be simply twisted e.g., unthreaded from the bottle) to reveal the channel opening through which items are dispensed. Thus, there is a good deal of flexibility in the way in which the present invention can be manufactured. Container 110, capture portion 122, connector 140, and lid or barrier 150 may all be manufactured integrally as a single mechanism, or capture portion 122, connector 140, and lid or barrier 150 may be manufactured integrally and configured to be subsequently slid into a container, or capture portion 122 and connector 140 may be manufactured separately for subsequent assembly with lid 150 and container 110, or all components may be manufactured separately and subsequently assembled, among other alternatives such as those discussed above.

The mechanisms are designed to dispense items or substances controllably, e.g., one item at a time, or a predefined volume each time, with a simple, single tilting motion. Such a motion is the most intuitive motion to a user who is acting to dispense or release an item or volume from a container, and as such, there is no learning requirement for use of the present invention. Capture of an item to be dispensed is accomplished through gravity feed of items from a reservoir within the container into a capture mechanism. An item may be dispensed by one-handed actuation, through a simple tilting motion, as referred to above.

Although described herein primarily with reference to medical items such as capsules, caplets and the like, the present invention is useful for dispensation of a wide variety of items such as hardware items (e.g., screws, bolts, etc.), candies and gums, office supplies (e.g., paper clips, tacks, etc.), nuts or other food or cooking items, ammunition, other physical items that typically come packaged in a container having a plurality of such items, only one or a portion of which are generally desired to be dispensed by a user at any one time, and even liquids.

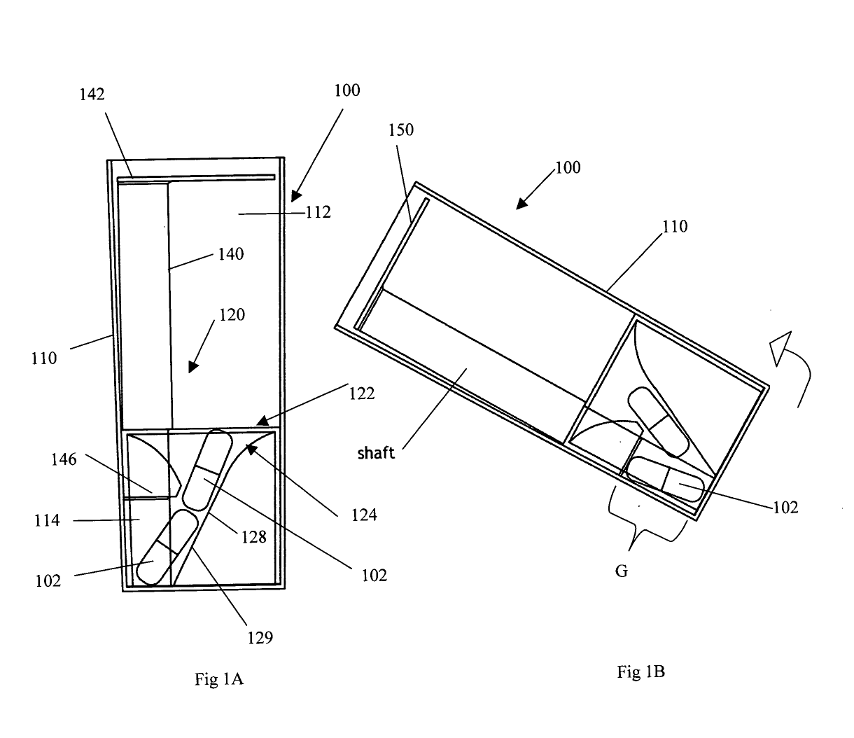

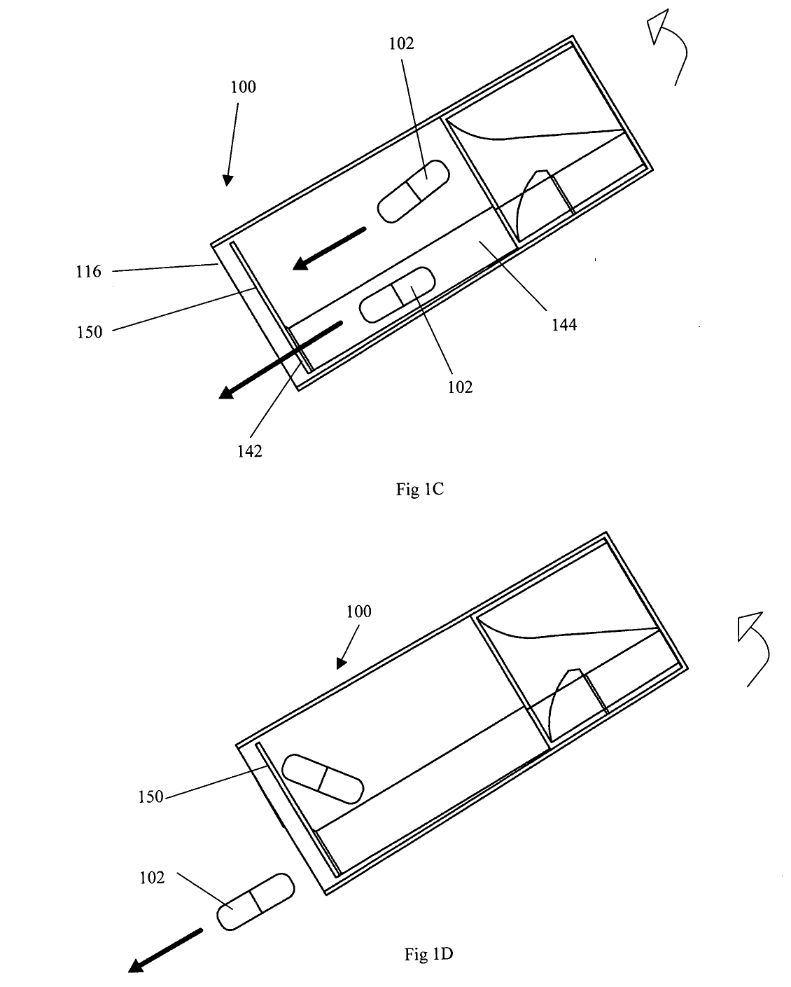

Referring now to FIG. 1A, a sectional view of an example of an item dispensing device 100 according to the present invention is shown. In the example shown, a dispensing mechanism 120 is provided within an existing container 110, which in this case is an off the shelf (either over-the-counter or prescription) “pill bottle” which is cylindrical and typically may be made of either glass or plastic. Alternatively, as noted above however, the dispensing mechanism may be manufactured together with a container already surrounding it. In the instant example, the dispensing mechanism is inserted into an existing container, and may be press fit, for example to maintain a fixed position within the container 110, although certainly, other methods for maintaining the dispensing mechanism 120 within the container 110 could be devised (e.g., heat bonding, adhesives, threads, or other know fixation techniques) and would be readily apparent to those of ordinary skill in the art.

Dispensing mechanism 120 includes a capture portion 122 which divides the interior of the outer container 110 between a reservoir space 112 and a capture space 114. Since the container 110 is cylindrical in FIG. 1A, the capture portion 122 is also formed to have a generally cylindrical shape in order to be press fit into container 110. However, the present invention is not limited to cylindrical containers, and may be applied to containers having square or rectangular cross-sections, or other shapes. In such instances, capture portion 122 is formed to have a similar cross-section shape, overall, although an opening is provided in the perimeter of the capture portion, as discussed below.

A connector 140 is provided to define a delivery channel from the capture portion 122 to an opening 142 for dispensation of items out of the container 110. For ease of manufacturing, connector 140 and capture portion 122 may be separately manufactured, such as by injection molding, for example. However, connector 140 and capture portion 122 could be manufactured integrally, by injection molding, or otherwise. For use with pharmaceuticals or food products, connector 140 and capture portion 122 should be made from food grade, FDA approved materials, such as polypropylene, polyethylene, or the like. However, in general, the components of the present invention may be manufactured from a variety of materials, including high volume manufacturing materials, such as, but not limited to plastics, thermoplastics, metals, etc.

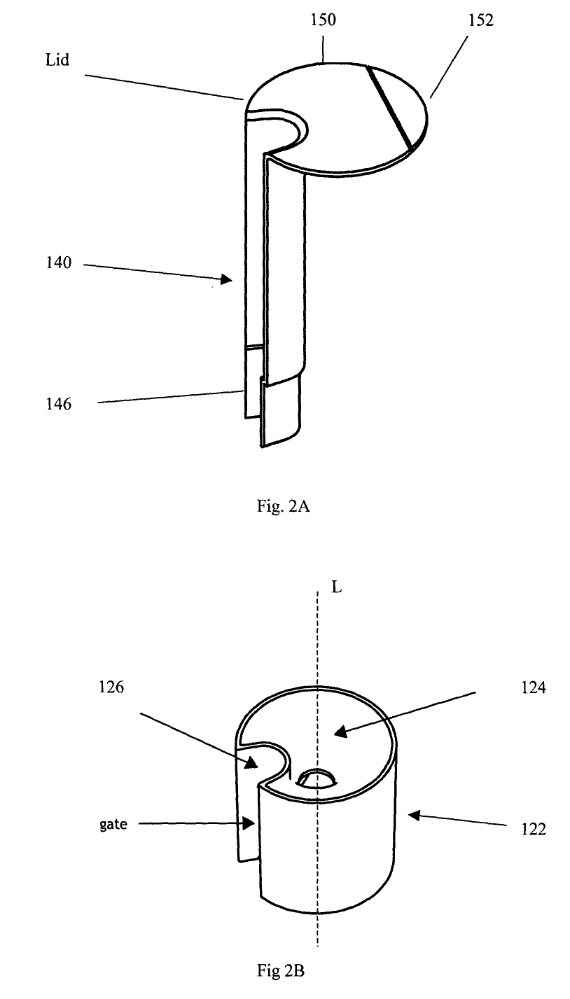

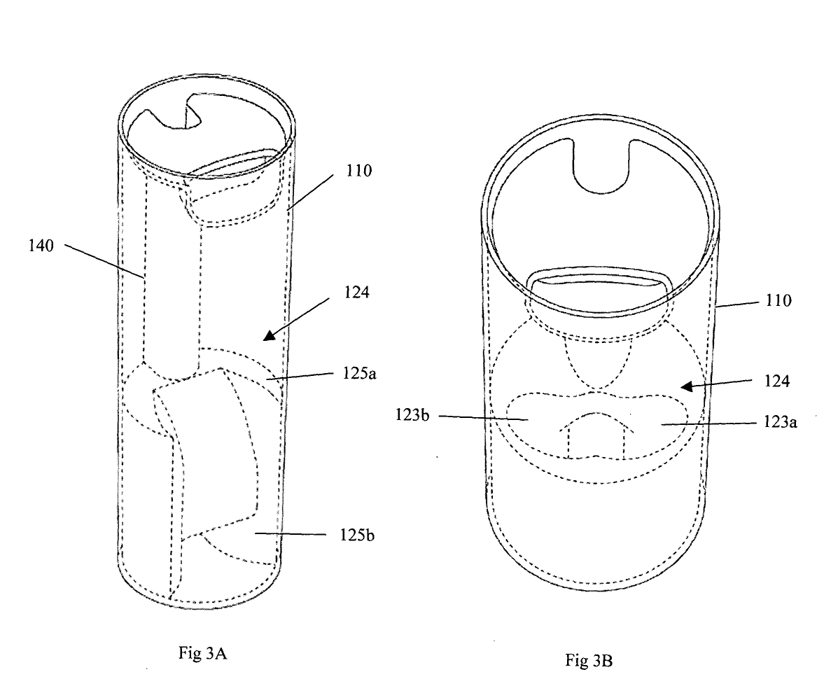

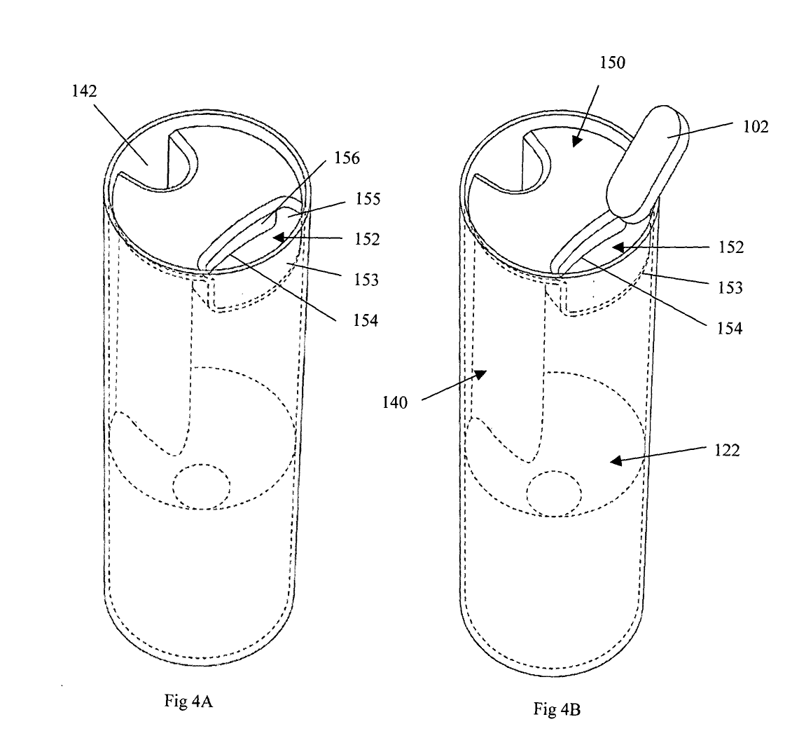

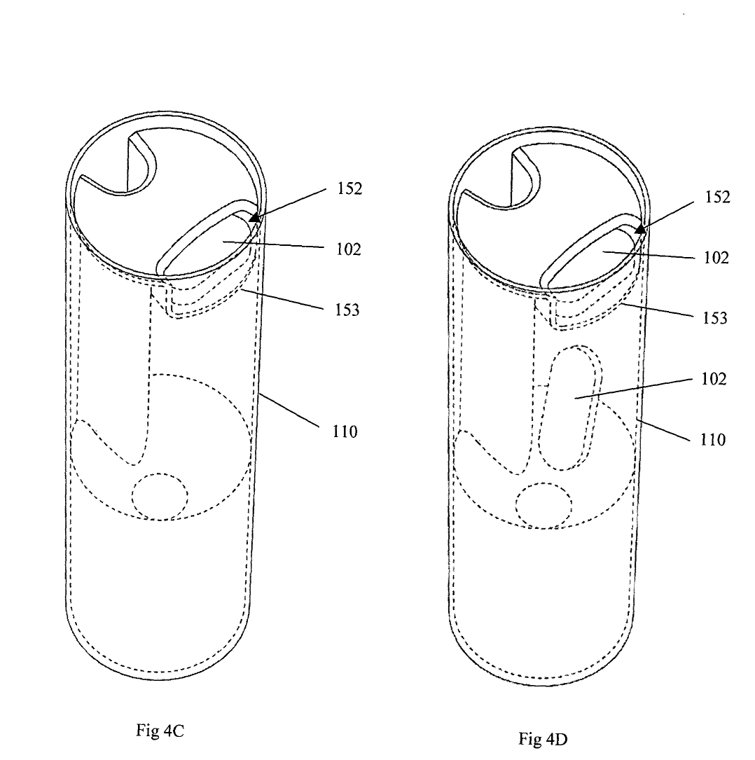

In the example shown in FIGS. 1A and 2B, capture portion 122 includes a funnel-shaped separator 124 which functions both to separate reservoir space 112 from capture space 114, as well as to guide items 102 into the capture space 114 to be controllably dispensed. Although shown as funnel-shaped, separator 124 is not limited to the shape shown, but may alternatively be formed as angular ramps, an irregularly shaped funnel, an asymmetric funnel or a series of funnels or multiple parallel funnels and openings. Additionally, each funnel shape (or alterative thereto), rather than leading to a single opening, may contain multiple reliefs (e.g., see reliefs 123a,123b in FIG. 3A) that lead to a single or multiple openings at the apical end thereof. The depth of each funnel may vary from deep to very shallow depending upon the size and shape of the items to be dispensed. The example of FIG. 3B shows a series of funnels, wherein separator 124 includes a first funnel-shaped member 125a oriented with its longitudinal axis substantially parallel to the longitudinal axis of container 110 and above a second funnel-shaped member 125b which is oriented with its longitudinal axis substantially perpendicular or transverse to the longitudinal axis of container 110.

Although the main axis L of the funnel-shape of separator 124 is shown to be substantially parallel with the longitudinal axis of container 110, axis L may be provided at any angle with respect to the longitudinal axis of container 110, from parallel to perpendicular. Further, funnel-shaped separator 124 may be inverted with respect to what is shown in FIG. 1A, in which case, the step of capturing an item is carried out when tilting container 110, which is described in more detail below.

Separator 124 focuses items 102 into capture space 114 where items are positioned in ready for dispensation. Capture portion 122 is provided with an opening or recess 126 which connects with capture space 114 and through which items are dispensed through connector 140 and out of container 110. A capture channel 128 connecting separator 124 and capture space 114 may optionally be provided, and may be also be longer or shorter than that shown. While lengthening the capture channel 128 allows for more pre-alignment of items at a time, and may be desirable for a dispenser designed to dispense two or more times at a time, such lengthening also has the effect of reducing the volume of reservoir 112. Thus, for single item dispensation, a short capture channel 128, as shown in FIG. 1A, or no capture channel at all may be desirable to maximize the capacity of reservoir 112. Capture space 114 may be of variable shape and size and relationship to related openings to provide for sizes and shapes or variations in volumes sizes desired to be predefined for dispensation.

Items 102 pass into capture space 114 under the force of gravity. Thus, for the example shown in FIG. 1A, when container 110 is an upright position as shown, items are channeled into position in the capture space 114, as shown. Capture portion 122 provides a support 129 which maintains item 102 in an orientation to be dispensed upon tilting the container 110 as shown in FIGS. I BID.

Upon tilting container 110, which may be accomplished by a simple hand motion of the user (only a single hand is required to perform this motion) in the direction shown by the arrow in FIG. 1B, item 102 falls into alignment with a dispensation channel 144 formed by connector 140 and the inner wall of container 110. Connector 140, when manufactured separately from capture portion 122, includes a recessed end portion 146 which is configured and sized to engage with recess 126 of capture portion 122, and extend into capture space 114 as shown in FIGS. 1A-1B, for example. The length of end portion 126 determines the distance by which it extends into capture space 114, and, together with the bottom of container 110, defines a gap having a predefined dimension G that prohibits more than a predefined number of items from entering the gap and being dispensed at one time. A dynamic relationship between capture portion 122 and the gap help determined both the number and size of items (or amount of a substance) to be released into the channel. In the example shown, the dimension of gap G is arranged to allow only a single item at a time to be dispensed. However, it would be possible to form a gap G to controllably dispense two items at a time, for example, or more.

When connector 140 and capture portion 122 are constructed integrally, end portion 146 is permanently fixed to form a predefined gap dimension G. However, when connector 140 and capture portion 122 are separately manufactured, capture portion may be provide so as to adjust the degree of insertion of end portion 146 into recess 126, so as to vary the dimension G. This feature allows use of mechanism 120 for controlled dispensation of items having a first size, and then adaptation of the mechanism so as to change the dimension G for use in controlled dispensation of items having a larger or smaller size than the first items. The degree of adjustment may be provided to be great enough to switch between dispensing items one at a time to two at a time, for example. Adjustment mechanisms may include détentes into which protrusions at locations along various lengths of the end portion 146 may be snap-fitted, or other equivalent snap fit adjustment means, threading, or the like. As another alternative, mechanism 112 may be provided as a kit, having a plurality of connectors 140 each having a different length of recessed end portion 146.

Upon continuation of the tilting motion as shown in FIG. 1C, the captured item 102 slides down dispensation channel 144 by the force of gravity, out of opening 142 and out the open end of container 110. The other item 102 shown in the capture portion 122 in FIG. 1B is prevented from passing through gap G in this example, and returns into reservoir 112 under the force of gravity during the tilting procedure, as shown in FIG. 1C. A barrier, such as lid 150, for example, extends from connector portion 140 and prevents the escape or dispensation of any items 102 from reservoir 112 when container 110 is tilted, as shown in FIG. 1D. Barrier 150 may be formed separately, or integrally with one or more of the other components described above.

Barrier 150 may be provided with an access feature 152 that allows a user to reinsert an item 102 or refill the reservoir with items 102 without the need to remove the entire connector 140 or entire dispensation mechanism 120 as the case may be. For example, FIG. 2A shows a hinged portion (in this example the actuation is through a living hinge, although alternative mechanisms may be employed) 152 which may be opened by the user to insert one or more items into reservoir 112. Upon completion of the insertion, hinged portion 152 may be snapped closed to maintain the integrity of the barrier during dispensation of items. Although the example of FIG. 2A employs a living hinge to permit an opening for access to reservoir 112, the use of an inherently malleable material for portion 52, in conjunction with making lid 150 of structurally rigid material may be used to provide the same functionality without the use of a living hinge.

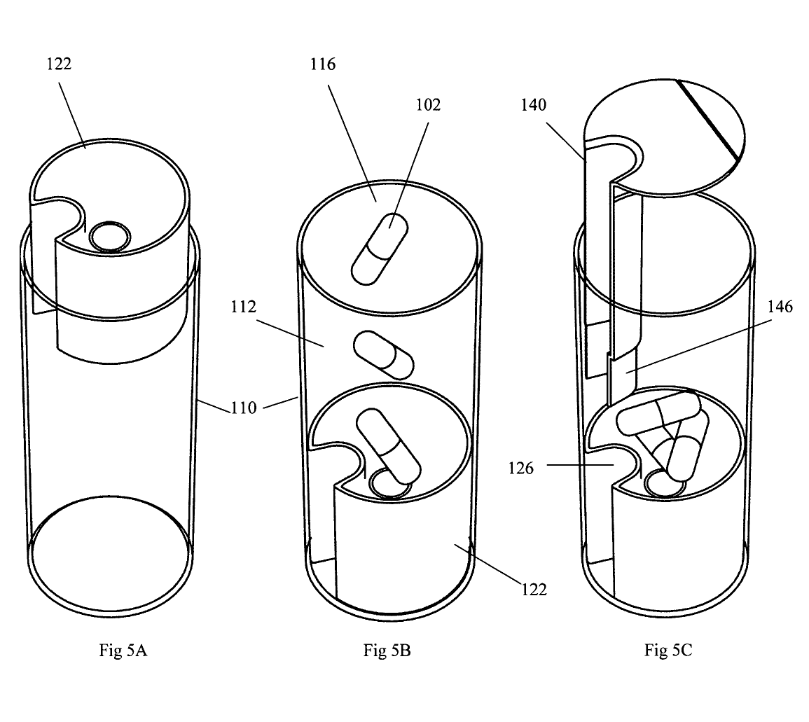

Alternatively, access feature 152 may be provided as a one way opening that requires intervention on the part of the user to reinsert an item 102. An alternative barrier design may employ an entry gate 154 through which an item 102 may be reinserted. Further alternatively, access feature 152 may be formed as an opening with a recessed ledge 154, as illustrated in FIGS. 5A-5D Opening 155 is designed to be only slightly larger than an item 102 which it is designed for use with, so that no more than one item 102 can be placed onto ledge 153 at a time, see FIGS. 5A-5B. Likewise, an opening 156 through which item 102 passes when traveling from ledge 153 to reservoir 112 is dimensioned only slightly larger than the dimensions of item 102 (see FIGS. 5C-5D), which greatly reduces the chances of items 102 escaping from reservoir and out of opening 155 during a dispensation, particularly, since the assembly is tilted toward opening 142, so that ledge 153 effectively shields opening 156 from allowing items to pass therethrough, even if an entry gate is not employed.

Optionally, entry gate 154 may be provided to further prevent unwanted passage of items 102 from reservoir 112. [symbol] of the container 110. Entry gate 154 may be designed such that light force must be applied to the item against the gate in order to force an item 102 through an opening that entry gate 154 covers when no force is applied. The applied force causes a slight expansion of the material of the barrier or a bending open of the material, thereby enlarging the opening at the entry gate to a size that allows the item to pass through, thereby reentering the reservoir 112.

FIGS. 5A-5C illustrate stages of adapting an existing medication bottle for use with a dispensing mechanism 120 according to the present invention. In this example, capture portion 122 is first inserted into container 110 (FIG. 5A) and is fixed at the bottom portion of container 110 either by press fitting or other equivalent fixation technique. Items 102 are next loaded (FIG. 5B) into container 110 through opening 116 of container 110, on top of capture portion 122 to occupy reservoir 112 created by the insertion of capture portion 122. Of course, one or more items 102 may pass into the capture portion 122 under gravity. At FIG. 5C, it is shown that connector portion 140 is next installed by connecting end portion 146 with recess 126 by a press fit, or other connection technique. Additionally, barrier 150 may be dimensioned to form a press fit with the inner wall of container 110. Optionally, openable portion 152 may be recessed slightly so as not to form a part of the press fit, for easier opening and closing. Further, the openable portion 152 may be provided with additional securement features of its own for securing the closed position, such as a detent or other “snap fitting” feature.

It is also to be noted that the steps described in FIGS. 5A-5C are non-limiting, since the connector portion 140 can be installed prior to loading items 102 into the reservoir, and this would be the steps actually taken for an assembly having an integral mechanism 120. Also, containers 120 may be manufactured to have an integral capture portion 122 or integral mechanism 120. Further alternatively, the barrier lid 150 may be formed separately, while the channel portion of connector portion 140 and capture portion 122 are formed integrally. In any case, the entire mechanism 120 may be received within container 110, so that a conventional cap (not shown) can be closed over the open end 116 of container 110 to help prevent contaminants of the contents, as well as to prevent inadvertent dispensation. Alternatively, mechanism 120 may be partially or entirely integrated with a cap or closure for a container (standard or otherwise) for functioning therewith.

By eliminating occurrences of excess dispensation and spilling, the present invention reduces items to exposure and contamination, as well as waste of items due to loss or contamination upon spilling. Since the present invention is easily operable with only one hand, it also provides an ease of use for controlled dispensation which has heretofore not been available.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. An item dispensing device for controllably dispensing a predefined number of items or a predefined volume of a substance at a time, said device comprising:
an outer container configured to contain a plurality of the items;
a capture portion contained within the outer container and dividing the outer container between a reservoir space, where the plurality of items are stored, and a capture space where individual items or predefined volumes of substances are captured for controlled dispensing, said capture portion defining the capture space to have a size and shape adapted to receive a particularly sized and shaped item or predefined volume of the substance;
a connector contained within the outer container and defining a delivery channel from said capture portion to an opening in the outer container from which items are dispensed; a first end portion of said connector extending into an opening in said capture portion and defining a predetermined gap dimension through which only the predetermined number of items may pass at one time; and
a barrier connecting with a second end portion of said connector and preventing release of the plurality of items from the reservoir space when the predetermined number of items is dispensed from said connector.

2. The device of claim 1, wherein the predefined number is one and wherein said predetermined gap dimension allows only one item to pass there through at a time.

3. The device of claim 1, wherein said connector is adjustable to adjust said predetermined gap dimension.

4. The device of claim 1, wherein said capture portion comprises a funnel-shaped separator.

5. The device of claim 1, wherein said connector comprises a channel extending from said first end portion, said channel adapted to interface with an inner wall of said outer container to define said delivery channel.

6. The device of claim 1, wherein items are gravitationally fed to said capture space.

7. The device of claim 1 adapted to dispense by gravitational feed resultant from a simple tilting motion that may be accomplished by one hand of a user.

8. An item dispensing assembly for controllably dispensing a predefined number of items at a time, said assembly adapted to be completely received within an item container, said assembly comprising:
a capture portion adapted to be contained within the item container and positioned to divide the item container between a reservoir space, where a plurality of items can be stored, and a capture space, where individual items are captured for controlled dispensing;
a connector adapted to be contained within the item container and configured to define a delivery channel from said capture portion to an opening in the item container from which items are dispensed; a first end portion of said connector extending into an opening in said capture portion and defining a predetermined gap dimension through which only the predetermined number of items may pass at one time; and
a barrier connecting with a second end portion of said connector and adapted to interface with inner walls of the item container to prevent release of the plurality of items from the reservoir space when the predetermined number of items is dispensed from said connector.

9. The assembly of claim 8, wherein the predefined number is one and wherein said predetermined gap dimension allows only one item to pass there through at a time.

10. The assembly of claim 8, wherein said connector is adjustable to adjust said predetermined gap dimension.

11. The assembly of claim 8, wherein said capture portion comprises a funnel-shaped separator.

12. The assembly of claim 8, wherein said capture portion includes a separator sized and configured to capture items of a predefined size and shape or a predefined volume of a flowable substance.

13. The assembly of claim 8, wherein said connector and said capture portion are integrally formed.

14. The assembly of claim 8, wherein said connector comprises a channel extending from said first end portion, said channel adapted to interface with an inner wall of the item container to define said delivery channel.

15. The assembly of claim 8, configured so that items are gravitationally fed to said capture space.

16. The assembly of claim 8, configured to dispense items by gravitational feed resultant from a simple tilting motion that may be accomplished by one hand of a user.

17. A method of dispensing items controllably, so that a predefined number of items is released at one time, said method comprising the steps of:
providing a dispensing device having a reservoir space, where a plurality of items are stored, and a capture space, where individual items are captured for dispensing;
capturing an item by the force of gravity; and
dispensing the item by a single tilting motion, while preventing items in the reservoir space from being dispensed.

18. The method of claim 17, wherein the item is also captured by gravity by the single tilting motion, prior to said dispensing, which is driven by the same tilting motion.

19. The method of claim 17, wherein the predefined number is one.

20. The method of claim 17, wherein said dispensing and tilting may be accomplished by only one hand of a user.

21. The method of claim 17, wherein the predefined number of items released at one time is governed by a gap interfacing said capture space and having a predefined dimension, said method further comprising altering said predefined dimension of said gap to dispense a different size item or change the predefined number of times to be dispensed at a time.
